(19) United States
(12) Patent Application Publication
(10) Pub. No.: US 2024/0284554 A1
(43) Pub. Date: Aug. 22, 2024

(54) CONNECTION RELEASE METHOD, CONNECTION RELEASE APPARATUS, AND STORAGE MEDIUM

(71) Applicant: Beijing Xiaomi Mobile Software Co., Ltd., Beijing (CN)

(72) Inventor: Xing YANG, Beijing (CN)

(21) Appl. No.: 18/569,999

(22) PCT Filed: Jun. 16, 2021
(86) PCT No.: PCT/CN2021/100366

§ 371 Date: Dec. 13, 2023

(51) Int. Cl. H04W 76/38; H04W 76/27

(52) U.S. Cl. CPC H04W 76/38; H04W 76/27

(57) ABSTRACT

A connection release method includes: in response to detecting a first data transmission of a remote user equipment (UE), determining a data inactivity timer corresponding to the remote UE, and controlling the data inactivity timer to start timing, the data inactivity timer being used for controlling the RRC connection of the remote UE.

### BACKGROUND

Generally, there are two ways for user equipment (UE) to release a radio resource control (RRC) connected state. One way is to configure a data inactivity timer for the UE by a network side device, if the data inactivity timer is in a timeout state, the UE will automatically release RRC connection. One way is to transmit an RRC connection release message to a terminal by a network side device, the UE will release RRC connection upon receiving that message.

### SUMMARY

A first aspect of an example of the disclosure provides a connection release method. The connection release method is applied to relay user equipment (UE) and includes:
determining, in response to detecting that remote UE transmits first data, a data inactivity timer corresponding to the remote UE, and controlling the data inactivity timer to start timing, where the data inactivity timer is configured to control radio resource control (RRC) connection of the remote UE.

A second aspect of an example of the disclosure provides a connection release method. The connection release method is applied to remote user equipment (UE) and further includes:
determining a data inactivity timer, where the data inactivity timer is controlled by a relay to start timing; and the relay determines to control the data inactivity timer to start timing on the basis of data transmitted by the remote UE; and transmitting data inactivity timer duration to relay UE.

A third aspect of an example of the disclosure provides a connection release method. The connection release method is applied to a network device and further includes:
determining a data inactivity timer, where the data inactivity timer is controlled by a relay to start timing; and the relay determines to control the data inactivity timer to start timing on the basis of data transmitted by the remote UE; and
transmitting data inactivity timer duration to relay UE, where the data inactivity timer duration corresponds to at least one of remote UE.

A fourth aspect of an example of the disclosure provides a connection release method. The connection release method is applied to remote user equipment (UE) and further includes:
determining a data inactivity timer; and determining, in response to detecting that second data is transmitted, to start timing by the data inactivity timer.

A fifth aspect of an example of the disclosure provides a connection release method. The connection release method is applied to relay UE and includes:
receiving a second instruction message, where the second instruction message is transmitted by the remote UE under the condition of timeout of a data inactivity timer, and the data inactivity timer starts timing when the remote UE detects that second data is transmitted.

A sixth aspect of an example of the disclosure provides a connection release method. The connection release method is applied to a network device and includes:
transmitting data inactivity timer duration to remote UE, where the data inactivity timer duration is used for configuring a timer by the remote UE, and the remote UE detects that second data is transmitted and determines to start timing by the data inactivity timer.

A seventh aspect of an example of the disclosure provides a connection release apparatus. The connection release apparatus includes:
a processor; and a memory configured to store an instruction executable by the processor. The processor is configured to execute the connection release method according to the first aspect or any one of the embodiments of the first aspect, or the connection release method according to the second aspect or any one of the embodiments of the second aspect, or the connection release method according to the third aspect or any one of the embodiments of the third aspect, or the connection release method according to the fourth aspect or any one of the embodiments of the fourth aspect, or the connection release method according to the fifth aspect or any one of the embodiments of the fifth aspect, or the connection release method according to the sixth aspect or any one of the embodiments of the sixth aspect.

An eighth aspect of an example of the disclosure provides a non-transitory computer-readable storage medium. When an instruction of the storage medium is executed by a processor of a mobile terminal, the mobile terminal can execute the connection release method according to the first aspect or any one of the embodiments of the first aspect, or the connection release method according to the second aspect or any one of the embodiments of the second aspect, or the connection release method according to the third aspect or any one of the embodiments of the third aspect, or the connection release method according to the fourth aspect or any one of the embodiments of the fourth aspect, or the connection release method according to the fifth aspect or any one of the embodiments of the fifth aspect, or the connection release method according to the sixth aspect or any one of the embodiments of the sixth aspect.

### BRIEF DESCRIPTION OF THE DRAWINGS

The accompanying drawings here are incorporated in the description as a constituent part of the description, illustrate examples conforming to the disclosure, and serve to describe principles of the disclosure together with the description.

FIG. 1 is an architecture diagram of a communication system of a network device and a terminal according to an example;

FIG. 2 is a schematic diagram of a communication structure of a connection release method according to an example;

FIG. 3 is a flow diagram of a connection release method according to an example;

FIG. 4 is a flow diagram of another connection release method according to an example;

FIG. 5 is a flow diagram of yet another connection release method according to an example;

FIG. 6 is a flow diagram of yet another connection release method according to an example;

FIG. 7 is a flow diagram of yet another connection release method according to an example;

FIG. 8 is a flow diagram of yet another connection release method according to an example;

FIG. 9 is a flow diagram of yet another connection release method according to an example;

FIG. 10 is a flow diagram of yet another connection release method according to an example;

FIG. 11 is a flow diagram of yet another connection release method according to an example;

FIG. 12 is a flow diagram of yet another connection release method according to an example;

FIG. 13 is a flow diagram of yet another connection release method according to an example;

FIG. 14 is a flow diagram of still another connection release method according to an example;

FIG. 15 is a block diagram of a connection release apparatus according to an example;

FIG. 16 is a block diagram of another connection release apparatus according to an example;

FIG. 17 is a block diagram of yet another connection release apparatus according to an example;

FIG. 18 is a block diagram of yet another connection release apparatus according to an example;

FIG. 19 is a block diagram of yet another connection release apparatus according to an example;

FIG. 20 is a block diagram of still another connection release apparatus according to an example;

FIG. 21 is a block diagram of an apparatus for releasing connection according to an example; and

FIG. 22 is a block diagram of another apparatus for releasing connection according to an example.

### DETAILED DESCRIPTION

Examples will be described in detail here and shown in the accompanying drawings illustratively. When the following descriptions involve the accompanying drawings, unless otherwise specified, the same numeral in different accompanying drawings denotes the same or similar elements. The embodiments described in the following examples do not denote all embodiments consistent with the disclosure. On the contrary, the embodiments are merely instances of an apparatus and a method consistent with some aspects of the disclosure as detailed in the appended claims.

The disclosure relates to the technical field of radio communication, and particularly relates to a connection release method, a connection release apparatus, and a storage medium.

Generally, there are two ways for UE to release a RRC connected state. One way is to configure a data inactivity timer for the UE by a network side device, if the data inactivity timer is in a timeout state, the UE will automatically release RRC connection. One way is to transmit an RRC connection release message to a terminal by a network side device, the UE will release RRC connection upon receiving that message. If the UE is configured with a data inactivity timer, the data inactivity timer will be restarted when media access control (MAC) receives a MAC service data unit (SDU) of a dedicated traffic channel (DTCH), a dedicated control channel (DCCH), and a common control channel (CCCH) channel, or MAC transmits an MAC SDU of a DTCH and a DCCH channel.

If the UE cannot be directly connected to a network device, the UE will be in communication with the network device by using another UE as relay UE, and UE that cannot be directly connected to the network device is remote UE. The remote UE is in communication with the relay UE through device to device communication. The device to device communication is a branch of cellular Internet of Things technology, and may also be referred to as Sidelink.

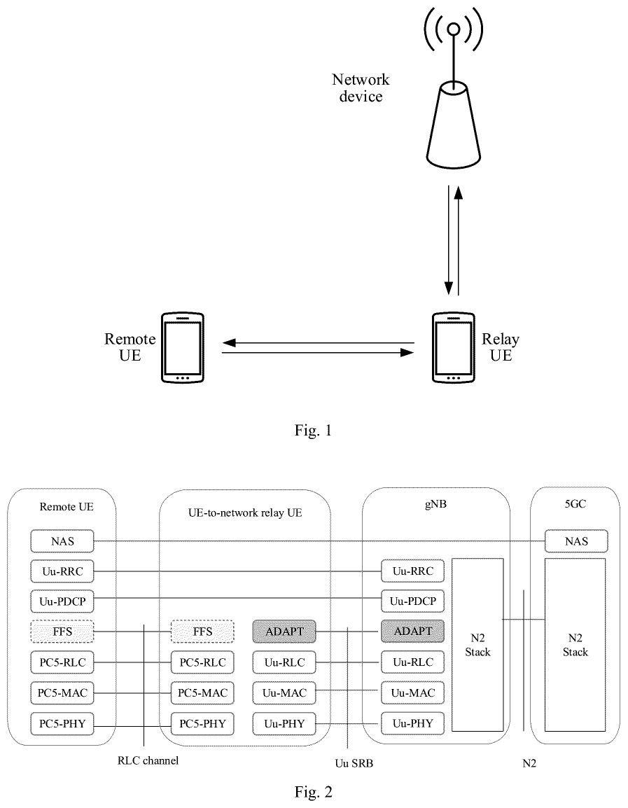

FIG. 1 is an architecture diagram of a communication system of a network device and a terminal according to an example. A connection release method provided in the disclosure may be applied to the architecture diagram of the communication system as shown in FIG. 1. As shown in FIG. 1, the network device may transmit signaling on the basis of the architecture shown in FIG. 1, and relay UE will forward the received signaling to remote UE upon receiving the signaling transmitted by the network device.

It may be understood that the communication system between the network device and the terminal as shown in FIG. 1 is only illustrative, and a radio communication system may further include other network devices, such as a core network device, a radio relay device, and a radio backhaul device, which are not shown in FIG. 1. The example of the disclosure does not limit the number of network devices and the number of terminals included in the radio communication system.

It should be noted that in order to achieve data relaying and forwarding, a logical channel of relay UE needs to have a correspondence with a logical channel of remote UE. The correspondence may be indicated by an adaptation layer (ADAPT). During data forwarding, an adaptation layer subheader needs to be added to a protocol data unit (PDU) of a packet data convergence protocol (PDCP) of the remote UE, and is configured to indicate an identifier of the remote UE and a logical channel identifier of the remote UE.

FIG. 2 is a schematic diagram of a communication structure of a connection release method according to an example, which includes remote UE, relay UE, a network device (for instance, gNB), and 5 generation core network (5GC). As shown in FIG. 2, the communication structure includes a network attached storage (NAS), a radio interface (a Uu interface), a radio link control (RLC) channel, Uu signalling radio bearers (SRBs), etc. A data packet may be processed and transmitted according to a protocol stack shown in FIG. 2.

For a remote UE that is connected to a network side device by means of a relay UE, it cannot be configured with a data inactivity timer because of its incapability of transmitting and receiving an MAC SDU of a DTCH, a DCCH, and a CCCH channel. If the remote UE determines to release an RRC connected state on the basis of a release message transmitted by the network side device, an error in receiving the release message transmitted by the network side device occurs probably. In consequence, connection states of a terminal determined by the UE and the network side device are inconsistent. Thus, the disclosure provides a connection release method. The relay UE controls a data inactivity timer of the remote UE to start, such that the data inactivity timer is configured for the remote UE, and further the problem that the UE and the network side device may obtain inconsistent connection states of the terminal is solved.

It may be further understood that a radio communication system of the example of the disclosure is a network providing a radio communication function. The radio communication system may use different communication technologies, such as code division multiple access (CDMA), wideband code division multiple access (WCDMA), time division multiple access (TDMA), frequency division multiple access (FDMA), orthogonal frequency-division multiple access (OFDMA), single carrier FDMA (SC-FDMA), and carrier sense multiple access with collision avoidance. According to capacity, speeds, delays and other factors of different networks, networks may be divided into a 2 generation (2G) network, a 3G network, a 4G network, or a future evolution network, for instance, a 5G network. The 5G network may also be referred to as new radio (NR) network. For convenience of description, a radio communication network is called a network for short in some cases in the disclosure.

Further, the network device involved in the disclosure may also be referred to as a radio access network device. The radio access network device may be a base station, an evolved node B, a home base station, an access point (AP) in a wireless fidelity (WIFI) system, a radio relay node, a radio backhaul node, a transmission point (TP), a transmission and reception point (TRP), etc., or may also be gNB in an NR system, or may also be a component or part of device that constitutes a base station. When the communication system is a vehicle-to-everything (V2X) communication system, the network device may also be a vehicle-mounted device. It should be understood that the example of the disclosure does not limit specific technologies and specific device forms used by the network device.

Further, the terminal involved in the disclosure may also be referred to as a terminal device, user equipment (UE), a mobile station (MS), a mobile terminal (MT), etc., and is a device that provides voice and/or data connectivity to a user. For instance, the terminal may be a handheld device having a radio connection function, a vehicle-mounted device, etc. At present, the terminal includes, for example, a mobile phone, a pocket personal computer (PPC), a palm computer, a personal digital assistant (PDA), a notebook computer, a tablet computer, a wearable device, or a vehicle-mounted device. In addition, when the communication system is a vehicle-to-everything (V2X) communication system, the terminal device may also be a vehicle-mounted device. It should be understood that the example of the disclosure does not limit specific technologies and specific device forms used by the terminal.

In order to solve problems in the related art, the disclosure provides a connection release method, a connection release apparatus, and a storage medium.

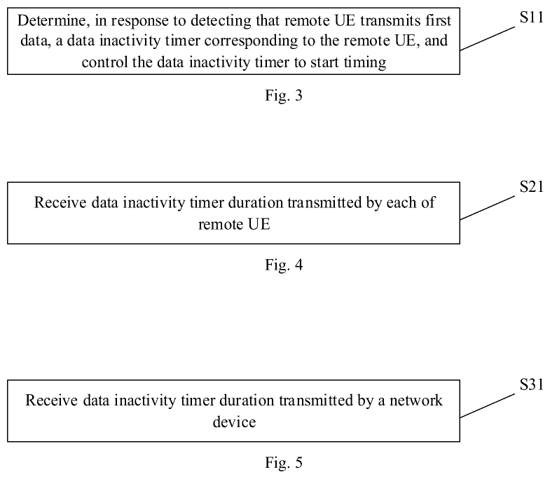

FIG. 3 is a flow diagram of a connection release method according to an example. As shown in FIG. 3, the connection release method is applied to relay UE and includes the following step:

In step S11, in response to detecting that remote UE transmits first data, a data inactivity timer corresponding to the remote UE is determined, and the data inactivity timer is controlled to start timing.

The data inactivity timer is configured to control RRC connection of the remote UE.

In the example of the disclosure, the relay UE determines the first data transmitted by the remote UE according to a data transceiving situation of a Uu interface. In response to detecting that the remote UE receives and transmits the first data, the data inactivity timer corresponding to the remote UE is determined, and the data inactivity timer is controlled to start timing. That is, the data inactivity timer is started or restarted.

The connection release method according to the example of the disclosure may configure the data inactivity timer for the remote UE, which is controlled by the relay UE, such that RRC connection may be released on the basis of the data inactivity timer. A problem that a remote UE state understood by the remote UE is inconsistent with that understood by the network device because the remote UE does not correctly receive a release message of the network device can be avoided.

In some examples of the disclosure, the relay UE may determine whether the remote UE transmits the first data on the basis of data information contained in the first data. If the relay UE detects the Uu interface and determines that data transmission or data reception exists in the Uu interface, it is determined that the first data is transmitted. It is determined that the remote UE transmits the first data if the first data contains at least one of the following:
an MAC SDU or an MAC PDU carrying a Uu bearer of the remote UE;
an MAC SDU or an MAC PDU carrying a PC5 bearer of the remote UE; and
an MAC SDU or an MAC PDU carrying data related to the remote UE.

The relay UE determines that the remote UE transmits the first data according to the fact that the received or transmitted MAC SDU carries the Uu bearer of the remote UE; or determines that the remote UE transmits the first data according to the fact that the received or transmitted MAC SDU carries the PC5 bearer of the remote UE; or determines that the remote UE transmits the first data according to the fact that the received or transmitted MAC SDU carries the data transmitted to or from the remote UE.

For instance, the relay UE determines whether an adaptation layer subheader carries an identifier of the remote UE. Then, on the basis of the identifier, the corresponding remote UE is determined. According to the MAC SDU corresponding to the remote UE, the data is forwarded to MAC of the remote UE.

In some examples of the disclosure, a relay UE may be regarded as a relay device for one or more pieces of remote UE. If a plurality of remote UE are provided, a data inactivity timer will be configured for each of remote UE, and each of remote UE correspond to different data inactivity timers. Certainly, each of remote UE may also be configured with the same data inactivity timer, or partially configured with the same data inactivity timer.

In some examples of the disclosure, different remote UE may also be configured with different data inactivity timer duration. Certainly, the UE may be configured with the same or partially the same data inactivity timer duration.

In an embodiment, FIG. 4 is a flow diagram of a connection release method according to an example. As shown in FIG. 4, the connection release method is applied to relay UE and includes the following step:

In step S21, data inactivity timer duration transmitted by each of remote UE is received.

A plurality of data inactivity timer duration are different or the same or partially the same. In the example of the disclosure, each of remote UE may be configured (bound) with a data inactivity timer duration, different remote UE may be configured with different data inactivity timer duration, and each of remote UE needs to report the configured data inactivity timer duration to the relay UE.

In another embodiment, FIG. 5 is a flow diagram of a connection release method according to an example. As shown in FIG. 5, the connection release method is applied to relay UE and includes the following step:

In step S31, data inactivity timer duration transmitted by a network device is received.

The data inactivity timer duration corresponds to at least one of remote UE.

In the example of the disclosure, the data inactivity timer duration of each of remote UE may be also determined by the network device. Relay UE receives at least one of data inactivity timer duration transmitted by the network device. For instance, the network device may configure a default data inactivity timer duration. The data inactivity timer duration may be applied to each of remote UE. Alternatively, each of remote UE may be configured with different data inactivity timer duration. In the example of the disclosure, step S31 may be implemented alone, or together with step S21 (for instance, the data inactivity timer duration is received from both the remote UE and the network device, and alternatively, when requesting of the data inactivity timer duration fails from one of the remote UE and the network device, the data inactivity timer duration is requested from the other one of the remote UE and the network device), or together with step S11.

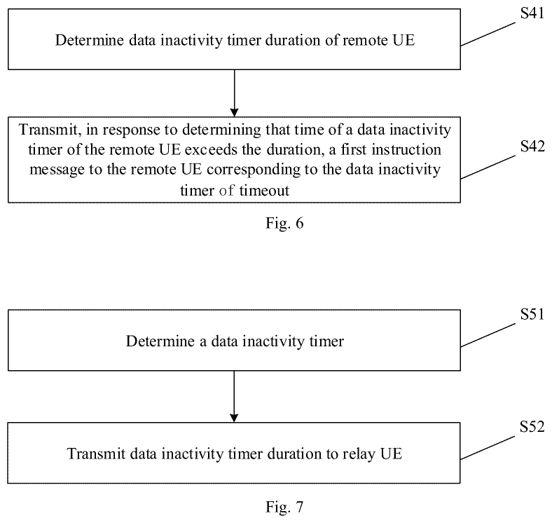

FIG. 6 is a flow diagram of a connection release method according to an example. As shown in FIG. 6, the connection release method is applied to relay UE and includes the following steps:

In step S41, data inactivity timer duration of remote UE is determined.

In step S42, in response to determining that time of a data inactivity timer of the remote UE exceeds the duration, a first instruction message is transmitted to the remote UE corresponding to the data inactivity timer that timed out.

In the example of the disclosure, if a plurality of remote UE are provided, the relay UE will determine the data inactivity timer duration of each of remote UE according to the received data inactivity timer duration transmitted by each of remote UE. If the time of the data inactivity timer exceeds the corresponding duration, the first instruction message will be transmitted to the remote UE corresponding to the data inactivity timer in the timeout state. The first instruction message may be configured to notify the remote UE of timeout of the data inactivity timer, alternatively, the first instruction message may be configured to notify the remote UE to release corresponding RRC connection and enter an idle state, and alternatively, the first instruction message may be configured to notify the remote UE to reestablish RRC connection.

In the example of the disclosure, step S41 that the data inactivity timer duration of the remote UE is determined includes the following step: the relay UE receives the data inactivity timer duration of the remote UE. In the example of the disclosure, step S41 that the data inactivity timer duration of the remote UE is determined includes the following step: the relay UE receives the data inactivity timer duration transmitted by a base station.

In some examples of the disclosure, the first instruction message may be configured to instruct the remote UE to enter an idle state. The first instruction message may also be configured to instruct the remote UE to reestablish an RRC connected state. The first instruction message may instruct the remote UE to execute an operation alone, may also instruct the remote UE to execute various operations of the above action, which is not limited here.

The data inactivity timer is configured for the remote UE, and the data inactivity timer of the remote UE is controlled to start timing on the basis of the relay UE, such that RRC connection may be released on the basis of the data inactivity timer. A problem that a remote UE state understood by the remote UE is inconsistent with that understood by the network device because the remote UE does not correctly receive a release message of the network device can be avoided.

On the basis of the same/similar concept, an example of the disclosure further provides a connection release method.

FIG. 7 is a flow diagram of a connection release method according to an example. As shown in FIG. 7, the connection release method is applied to remote UE and includes the following steps:

In step S51, a data inactivity timer is determined.

In the example of the disclosure, the data inactivity timer is controlled by relay UE to start timing. The relay UE determines to control the data inactivity timer to start timing on the basis of data transmitted by the remote UE. That is, the relay UE determines the first data transmitted by the remote UE according to a data transceiving situation of a Uu interface. In response to detecting that the remote UE receives and transmits the first data, the data inactivity timer corresponding to the remote UE is determined, and the data inactivity timer is controlled to start timing. In other words, the data inactivity timer is started or restarted.

In step S52, data inactivity timer duration is transmitted to the relay UE.

The connection release method according to the example of the disclosure may configure the data inactivity timer for the remote UE, which is controlled by the relay UE, such that RRC connection may be released on the basis of the data inactivity timer. A problem that a remote UE state understood by the remote UE is inconsistent with that understood by the network device because the remote UE does not correctly receive a release message of the network device can be avoided. In the example of the disclosure, the remote UE may transmit the data inactivity timer duration configured by a network device to the relay UE. The relay UE may execute a corresponding operation on the basis of the received data inactivity timer duration. The corresponding operation may be to transmit a first instruction message, control the data inactivity timer to start timing, etc. Reference may be made to the above examples. In the example of the disclosure, step S51 and S52 may be implemented alone, may also be implemented together with step S21, or together with S11, or together with steps of other examples of the disclosure.

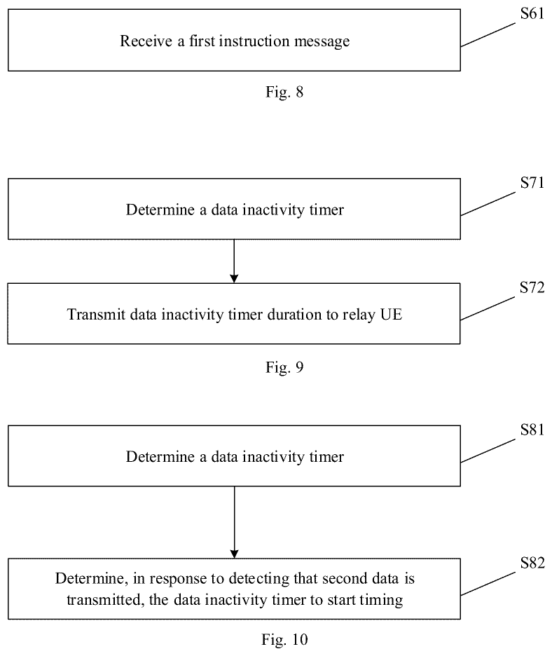

FIG. 8 is a flow diagram of a connection release method according to an example. As shown in FIG. 8, the connection release method is applied to remote UE and includes the following step:

In step S61, a first instruction message is received.

In the example of the disclosure, the remote UE receives the first instruction message transmitted by relay UE, may determine a data inactivity timer according to the first instruction message, and may execute an operation of entering an idle state and/or reestablishing an RRC connected state on the basis of the first instruction message. In the example of the disclosure, step S61 may be implemented alone, or together with step S51 and S52, or together with step S21, or together with steps of other examples of the disclosure.

On the basis of the same/similar concept, an example of the disclosure further provides a connection release method.

FIG. 9 is a flow diagram of a connection release method according to an example. As shown in FIG. 9, the connection release method is applied to a network device and includes the following steps:

In step S71, a data inactivity timer is determined.

In the example of the disclosure, the data inactivity timer is controlled by relay UE to start timing. The relay UE determines to control the data inactivity timer to start timing on the basis of data transmitted by the remote UE. That is, the relay UE determines the first data transmitted by the remote UE according to a data transceiving situation of a Uu interface. In response to detecting that the remote UE receives and transmits the first data, the data inactivity timer corresponding to the remote UE is determined, and the data inactivity timer is controlled to start timing. In other words, the data inactivity timer is started or restarted.

In step S72, data inactivity timer duration is transmitted to the relay UE.

The data inactivity timer duration corresponds to at least one of remote UE.

The connection release method according to the example of the disclosure may configure the data inactivity timer for the remote UE, which is controlled by the relay UE, such that RRC connection may be released on the basis of the data inactivity timer. A problem that a remote UE state understood by the remote UE is inconsistent with that understood by the network device because the remote UE does not correctly receive a release message of the network device can be avoided.

In the example of the disclosure, the data inactivity timer of each of remote UE may be configured uniformly by the network device, and alternatively, each of remote UE may be configured with a different data inactivity timer. For instance, the network device may be configured with a default data inactivity timer duration. The data inactivity timer duration may be applied to each of remote UE. Alternatively, each of remote UE may be configured with different data inactivity timer duration. In the example of the disclosure, step S71 and step S72 may be implemented alone, or together with step S31, or together with step S11, or together with step S41, or together with steps of other examples of the disclosure.

On the basis of the same/similar concept, an example of the disclosure further provides a connection release method.

FIG. 10 is a flow diagram of a connection release method according to an example. As shown in FIG. 10, the connection release method is applied to remote UE and includes the following steps:

In step S81, a data inactivity timer is determined.

In step S82, in response to detecting that second data is transmitted, the data inactivity timer is determined to start timing.

In the example of the disclosure, the remote UE detects that the second data is transmitted according to a sidelink interface, the data inactivity timer is determined to start timing.

The connection release method according to the example of the disclosure may configure the data inactivity timer for the remote UE, and the remote UE may control the data inactivity timer to start timing according to the configured data inactivity timer, thereby executing RRC connection release operations based on the data inactive timer. A problem that a remote UE state understood by the remote UE is inconsistent with that understood by the network device because the remote UE does not correctly receive a release message of the network device can be avoided.

In some examples of the disclosure, the second data includes at least one of the following:
a sidelink MAC SDU or a sidelink MAC PDU carrying a Uu bearer of the remote UE; and
an MAC SDU or an MAC PDU carrying data transmitted to a base station.

In the example of the disclosure, step S81 and S82 may be implemented alone, or together with steps of other examples of the disclosure.

FIG. 11 is a flow diagram of a connection release method according to an example. As shown in FIG. 11, the connection release method is applied to remote UE and includes the following steps:

In step S91, data inactivity timer duration transmitted by a network device is received.

In step S92, a first operation is executed in response to timeout of a data inactivity timer.

In the example of the disclosure, the data inactivity timer duration of the remote UE is determined on the basis of a network device. In other words, the network device configures the data inactivity timer duration for each of remote UE. The remote UE determines the corresponding data inactivity timer duration. If time of the data inactivity timer exceeds the data inactivity timer duration configured by the network device, the first operation will be operated.

The first operation includes at least one of the following operations:
entering an idle state;
reestablishing an RRC connected state; and
transmitting a second instruction message to relay UE.

That is, the remote UE determines that the time of the data inactivity timer exceeds the data inactivity timer duration configured by the network device, and is triggered to enter the idle state; and/or, the remote UE is triggered to reestablish the RRC connected state; and/or, the second instruction message is transmitted to the relay UE. In other words, the remote UE notifies the relay UE that the time of the data inactivity timer exceeds the data inactivity timer duration configured by the network device.

In the example of the disclosure, the second instruction message is configured to indicate a connection state of the remote UE; and/or the second instruction message is configured to instruct the relay UE to release a Uu bearer corresponding to the remote UE. The second instruction message is configured to indicate that the connection state of the remote UE may be that the remote UE enters the idle state.

In the example of the disclosure, step S91 and S92 may be implemented alone, or together with steps of other examples of the disclosure.

On the basis of the same/similar concept, an example of the disclosure further provides a connection release method.

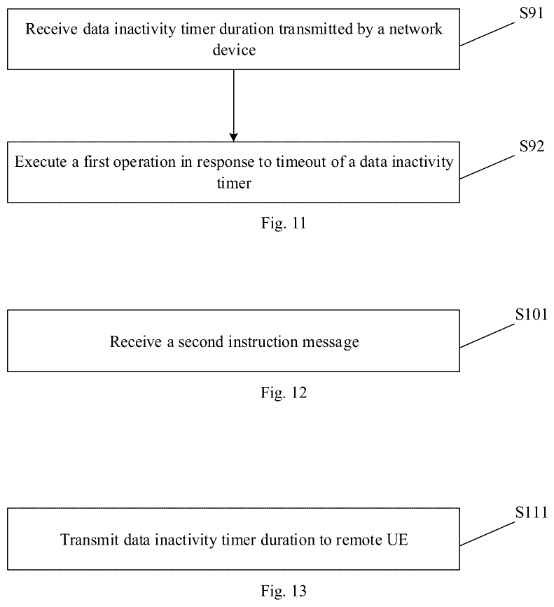

FIG. 12 is a flow diagram of a connection release method according to an example. As shown in FIG. 12, the connection release method is applied to relay UE and includes the following step:

In step S101, a second instruction message is received.

In the example of the disclosure, the second instruction message is transmitted by remote UE under the condition of timeout of a data inactivity timer, and the data inactivity timer starts timing when the remote UE detects that second data is transmitted. In other words, the remote UE is configured with the data inactivity timer, and the remote UE determines to start timing by the data inactivity timer in response to detecting that the second data is transmitted. If the time of the data inactivity timer exceeds preset data inactivity timer duration, the second instruction message will be transmitted to the relay UE.

The connection release method according to the example of the disclosure may configure the data inactivity timer for the remote UE, and the remote UE may control the data inactivity timer to start timing according to the configured data inactivity timer, thereby executing RRC connection release operations based on the data inactive timer. A problem that a remote UE state understood by the remote UE is inconsistent with that understood by the network device because the remote UE does not correctly receive a release message of the network device can be avoided.

In some examples of the disclosure, the second instruction message is configured to indicate a connection state of the remote UE; and/or the second instruction message is configured to instruct the relay UE to release a Uu bearer corresponding to the remote UE.

In some examples of the disclosure, after receiving the second instruction message transmitted by the remote UE, the relay UE may execute at least one of the following operations:
releasing a Uu bearer corresponding to the remote UE; and
transmitting a third instruction message to a network device.

The third instruction message is configured to indicate timeout of the data inactivity timer of the remote UE. That is, the relay UE may notify the network device of the remote UE entering an idle state.

In the example of the disclosure, step S101 may be implemented alone, or together with steps of other examples of the disclosure.

On the basis of the same/similar concept, an example of the disclosure further provides a connection release method.

FIG. 13 is a flow diagram of a connection release method according to an example. As shown in FIG. 13, the connection release method is applied to a network device and includes the following step:

In step S111, data inactivity timer duration is transmitted to remote UE.

In the example of the disclosure, the data inactivity timer duration is used for configuring the data inactive timer by the remote UE; and the remote UE detects that second data is transmitted and determines to start timing by the data inactivity timer.

In other words, the remote UE is configured with the data inactivity timer, and the remote UE determines to start timing by the data inactivity timer in response to detecting that the second data is transmitted. If the time of the data inactivity timer exceeds preset data inactivity timer duration, the second instruction message will be transmitted to the relay UE.

The connection release method according to the example of the disclosure may configure the data inactivity timer for the remote UE, and the remote UE may control the data inactivity timer to start timing according to the configured data inactivity timer, thereby executing RRC connection release operations based on the data inactive timer. A problem that a remote UE state understood by the remote UE is inconsistent with that understood by the network device because the remote UE does not correctly receive a release message of the network device can be avoided.

In the example of the disclosure, step S111 may be implemented alone, or together with steps of other examples of the disclosure.

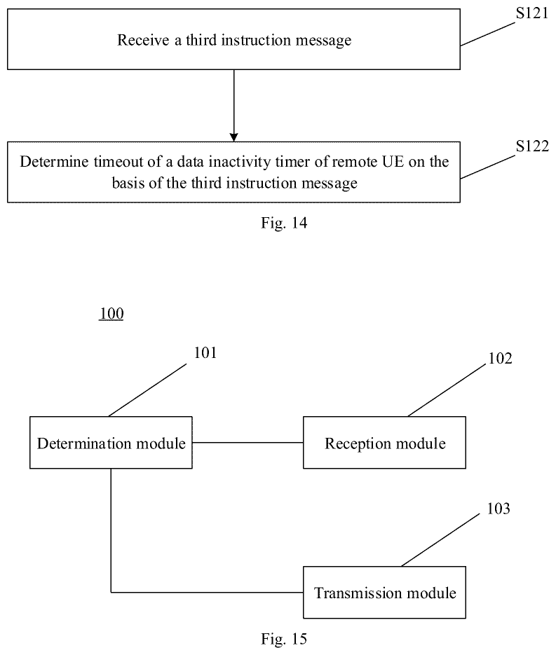

FIG. 14 is a flow diagram of a connection release method according to an example. As shown in FIG. 14, the connection release method is applied to a network device and includes the following steps:

In step S121, a third instruction message is received.

In step S122, timeout of a data inactivity timer of remote UE is determined on the basis of the third instruction message.

In the example of the disclosure, the network device receives the third instruction message transmitted by relay UE, determines that terminal UE data is inactive on the basis of the third instruction message, and may further determine that the remote UE enters an idle state.

In the example of the disclosure, step S121 and S122 may be implemented alone, or together with steps of other examples of the disclosure.

On the basis of the same concept, an example of the disclosure further provides a connection release apparatus.

It may be understood that the connection release apparatus according to the example of the disclosure includes corresponding hardware structures and/or software modules for executing respective functions, so as to achieve the above functions. In combination with units and algorithmic steps of each instance disclosed in the example of the disclosure, the example of the disclosure may be implemented in the form of hardware or a combination of hardware and computer software. Whether some function is executed in a mode of hardware or of driving hardware by computer software depends on a specific application and design constraints of the technical solution. Those skilled in the art may achieve the described functions for each particular application through different methods, but such implementation is not considered to be beyond the scope of the technical solution of the example of the disclosure.

FIG. 15 is a block diagram of a connection release apparatus according to an example. With reference to FIG. 15, the connection release apparatus 100 is applied to relay user equipment (UE) and includes a determination module 101.

The determination module 101 is configured to determine, in response to detecting that remote UE transmits first data, a data inactivity timer corresponding to the remote UE, and control the data inactivity timer to start timing. The data inactivity timer is configured to control RRC connection of the remote UE.

In an example of the disclosure, the first data includes at least one of the following:
a media access control (MAC) service data unit (SDU) or a media access control (MAC) protocol data unit (PDU) carrying a radio interface (Uu interface) bearer of the remote UE;
an MAC SDU or an MAC PDU carrying a sidelink PC5 bearer of the remote UE; and
an MAC SDU or an MAC PDU carrying data related to the remote UE.

In an example of the disclosure, a plurality of the remote UE are provided.

The apparatus further includes: a reception module 102.

The reception module 102 is configured to receive data inactivity timer duration transmitted by each of remote UE.

In an example of the disclosure, a plurality of the remote UE are provided.

The reception module 102 is further configured to receive data inactivity timer duration transmitted by a network device. The data inactivity timer duration corresponds to at least one of remote UE.

In an example of the disclosure, the determination module 101 is further configured to determine the data inactivity timer duration of the remote UE.

The apparatus further includes: a transmission module 103.

The transmission module 103 is configured to transmit, in response to exceeding the data inactivity timer duration, a first instruction message to the remote UE corresponding to the data inactivity timer that timed out.

In an example of the disclosure, the first instruction message is configured to instruct the remote UE to enter an idle state, and/or to instruct the remote UE to reestablish an RRC connected state.

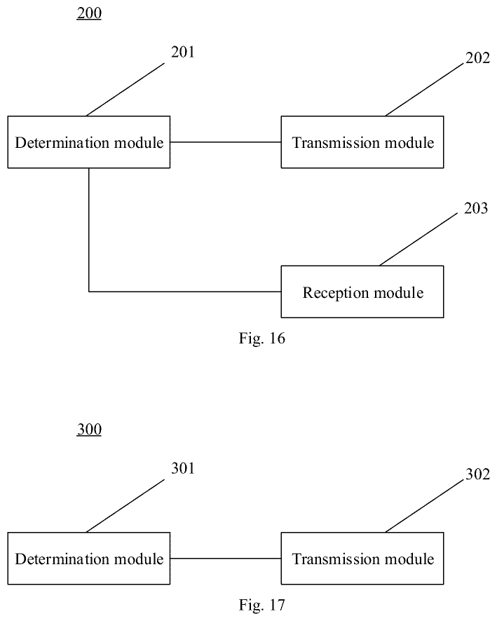

FIG. 16 is a block diagram of a connection release apparatus according to an example. With reference to FIG. 16, the connection release apparatus 200 is applied to remote user equipment (UE) and includes a determination module 201.

The determination module 201 is configured to determine a data inactivity timer. The data inactivity timer is controlled by a relay to start timing. The relay determines to control the data inactivity timer to start timing on the basis of data transmitted by the remote UE.

In an example of the disclosure, the apparatus further includes a transmission module 202.

The transmission module 202 is configured to transmit data inactivity timer duration to relay UE.

In an example of the disclosure, the apparatus further includes: a reception module 203.

The reception module 203 is configured to receive a first instruction message transmitted by the relay UE. The first instruction message is configured to instruct the remote UE to enter an idle state, and/or to instruct the remote UE to reestablish an RRC connected state.

FIG. 17 is a block diagram of a connection release apparatus according to an example. With reference to FIG. 17, the connection release apparatus 300 is applied to a network device and includes a determination module 301 and a transmission module 302.

The determination module 301 is configured to determine a data inactivity timer. The data inactivity timer is controlled by a relay to start timing. The relay determines to control the data inactivity timer to start timing on the basis of data transmitted by the remote UE.

The transmission module 302 is configured to transmit data inactivity timer duration to relay UE. The data inactivity timer duration corresponds to at least one of remote UE.

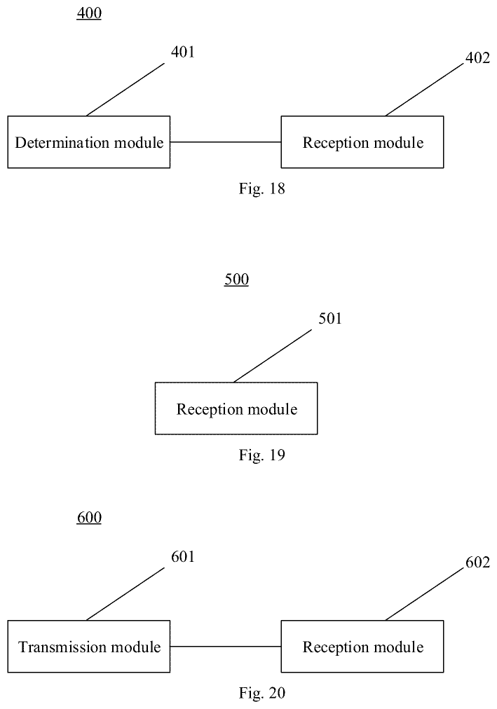

FIG. 18 is a block diagram of a connection release apparatus according to an example. With reference to FIG. 18, the connection release apparatus 400 is applied to remote user equipment (UE) and includes a determination module 401.

The determination module 401 is configured to determine a data inactivity timer; and determine, in response to detecting that second data is transmitted, the data inactivity timer to start timing.

In an example of the disclosure, the second data includes at least one of the following:
a sidelink media access control (MAC) service data unit (SDU) or a sidelink media access control (MAC) protocol data unit (PDU) carrying a Uu bearer of the remote UE; and
an MAC SDU or an MAC PDU carrying data transmitted to a base station.

In an example of the disclosure, the apparatus further includes: a reception module 402.

The reception module 402 is configured to receive data inactivity timer duration transmitted by a network device; and execute a first operation in response to timeout of a data inactivity timer.

In an example of the disclosure, the first operation includes at least one of the following operations:
entering an idle state.
reestablishing an RRC connected state, and
transmitting a second instruction message to relay UE.

In an example of the disclosure, the second instruction message is configured to indicate a connection state of the remote UE, and/or the second instruction message is configured to instruct the relay UE to release a Uu bearer corresponding to the remote UE.

FIG. 19 is a block diagram of a connection release apparatus according to an example. With reference to FIG. 19, the connection release apparatus 500 is applied to relay UE and includes a reception module 501.

The reception module 501 is configured to receive a second instruction message. The second instruction message is transmitted by remote UE under the condition of timeout of a data inactivity timer, and the data inactivity timer starts timing when the remote UE detects that second data is transmitted.

In an example of the disclosure, the second instruction message is configured to indicate a connection state of the remote UE, and/or the second instruction message is configured to instruct the relay UE to release a Uu bearer corresponding to the remote UE.

In an example of the disclosure, after the second instruction message is received, the relay UE executes at least one of the following operations:
releasing a Uu bearer corresponding to the remote UE; and transmitting a third instruction message to a network device. The third instruction message is configured to indicate timeout of the data inactivity timer of the remote UE.

FIG. 20 is a block diagram of a connection release apparatus according to an example. With reference to FIG. 20, the connection release apparatus 600 is applied to a network device and includes a transmission module 601.

The transmission module 601 is configured to transmit data inactivity timer duration to remote UE. The data inactivity timer duration is used for configuring the data inactive timer by the remote UE; and the remote UE detects that second data is transmitted and determines to start timing by the data inactivity timer.

In an example of the disclosure, the apparatus further includes: a reception module 602.

The reception module is configured to receive a third instruction message; and determine timeout of the data inactivity timer of the remote UE on the basis of the third instruction message.

For the apparatus in the above examples, a specific method for each module to execute an operation is described in detail in the examples relating to the method, and will not be described in detail here.

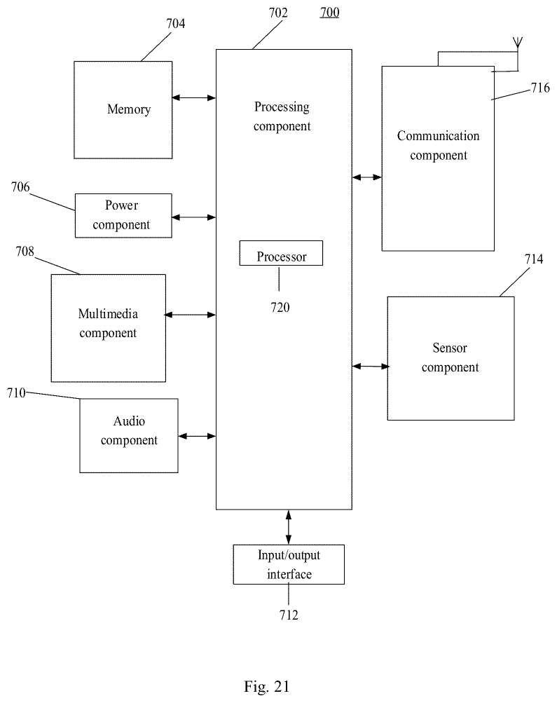

FIG. 21 is a block diagram of an apparatus 700 for releasing connection according to an example. For instance, the apparatus 700 may be a mobile phone, a computer, a digital broadcast terminal, a messaging device, a game console, a tablet device, a medical device, a fitness device, a personal digital assistant, etc.

With reference to FIG. 21, the apparatus 700 may include one or more of the following components: a processing component 702, a memory 704, a power component 706, a multimedia component 708, an audio component 710, an input/output (I/O) interface 712, a sensor component 714, and a communication component 716.

The processing component 702 generally controls all operations of the apparatus 700, such as operations associated with display, telephone call, data communication, camera operation and recording operation. The processing component 702 may include one or more processors 720 configured to execute an instruction, so as to complete all or some steps of the method. In addition, the processing component 702 may include one or more modules to facilitate interaction between the processing component 702 and other components. For instance, the processing component 702 may include a multimedia module to facilitate interaction between the multimedia component 708 and the processing component 702.

The memory 704 is configured to store various types of data, so as to support the operations on the apparatus 700. Instances of the data include an instruction for any application or method operating on the apparatus 700, contact data, phone book data, a message, a picture, a video, etc. The memory 704 may be implemented by any type of volatile or nonvolatile memory device or their combinations, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk, or an optical disk.

The power component 706 supplies power to various assemblies of the apparatus 700. The power component 706 may include a power management system, one or more power supplies, and other assemblies associated with generating, managing and distributing power for the apparatus 700.

The multimedia component 708 includes a screen that provides an output interface between the apparatus 700 and a user. In some examples, the screen may include a liquid crystal display (LCD) and a touch panel (TP). If the screen includes the touch panel, the screen will be implemented as a touch screen to receive an input signal from the user. The touch panel includes one or more touch sensors to sense touch, slide and gestures on the touch panel. The touch sensor may sense a boundary of a touch or slide operation, and detect duration and pressure related to the touch or slide operation. In some examples, the multimedia component 708 includes a front-facing camera and/or a rear-facing camera. When the apparatus 700 is in an operation mode, such as a photographing mode or a video mode, the front-facing camera and/or the rear-facing camera may receive external multimedia data. Each of the front-facing camera and the rear-facing camera may be a fixed optical lens system or have a focal length and optical zoom capability.

The audio component 710 is configured to output and/or input an audio signal. For instance, the audio component 710 includes a microphone (MIC). The microphone is configured to receive an external audio signal when the apparatus 700 is in operation modes such as a call mode, a recording mode and a speech identification mode. The received audio signal may be further stored in the memory 704 or transmitted via the communication component 716. In some examples, the audio component 710 further includes a speaker configured to output an audio signal.

The I/O interface 712 provides an interface between the processing component 702 and a peripheral interface module. The peripheral interface module may be a keyboard, a click wheel, a button, etc. The buttons may include, but are not limited to, a home button, a volume button, a start button, and a lock button.

The sensor component 714 includes one or more sensors for providing various aspects of state assessment for the apparatus 700. For instance, the sensor component 714 may detect an on/off state of the apparatus 700 and relative positioning of the assemblies such as a display and a keypad of the apparatus 700, and the sensor component 714 may further detect position change of the apparatus 700 or a component of the apparatus 700, presence or absence of contact between the user and the apparatus 700, an orientation or acceleration/deceleration of the apparatus 700 and temperature change of the apparatus 700. The sensor component 714 may include a proximity sensor configured to detect presence of a nearby object without any physical contact. The sensor component 714 may further include an optical sensor, such as a complementary metal-oxide-semiconductor (CMOS) or charge-coupled device (CCD) image sensor, which is applied to imaging application. In some examples, the sensor component 714 may further include an acceleration sensor, a gyroscope sensor, a magnetic sensor, a pressure sensor, or a temperature sensor.

The communication component 716 is configured to facilitate wired or radio communication between the apparatus 700 and other devices. The apparatus 700 may access a wireless network based on a communication standard, such as WiFi, the 2nd generation mobile communication technology (2G) or the 3rd generation mobile communication technology (3G), or their combination. In an example, the communication component 716 receives a broadcast signal or broadcast related information from an external broadcast management system via a broadcast channel. In an example, the communication component 716 further includes a near field communication (NFC) module to facilitate short-range communication. For instance, the NFC module may be implemented on the basis of a radio frequency identification (RFID) technology, an infrared data association (IrDA) technology, an ultra wide band (UWB) technology, a Bluetooth (BT) technology or other technologies.

In an example, the apparatus 700 may be implemented by one or more of an application specific integrated circuit (ASIC), a digital signal processor (DSP), a digital signal processing device (DSPD), a programmable logic device (PLD), a field programmable gate array (FPGA), a controller, a microcontroller, a microprocessor or other electronic components, thus executing the method.

In an example, there is further provided a non-transitory computer-readable storage medium including an instruction, such as the memory 704 including an instruction. The instruction may be executed by the processor 720 of the apparatus 700 so as to complete the method. For instance, the non-transitory computer-readable storage medium may be ROM, a random access memory (RAM), CD-ROM, a magnetic tape, a floppy disk, an optical data storage device, etc.

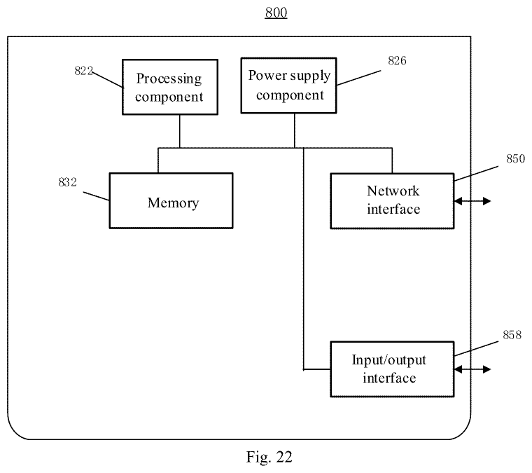

FIG. 22 is a block diagram of an apparatus 800 for releasing connection according to an example. For example, the apparatus 800 may be provided as a server. With reference to FIG. 22, the apparatus 800 includes a processing component 822, which further includes one or more processors, and a memory resource represented by a memory 832, which is configured to store an instruction executable by the processing component 822, such as an application. The application stored in the memory 832 may include one or more modules that each corresponds to a group of instructions. In addition, the processing component 822 is configured to execute the instruction, so as to execute the above method.

The apparatus 800 may further include a power supply component 826 configured to execute power management of the apparatus 800, a wired or radio network interface 850 configured to connect the apparatus 800 to a network, and an input/output (I/O) interface 858. The apparatus 800 may operate based on an operating system stored in the memory 832, such as Windows Server™, Mac OS X™, Unix™, Linux™ and FreeBSD™.

It may be further understood that “a plurality of” in the disclosure refers to two or above, and that other quantifiers are understood in a similar way. When describing an association relation of associated objects, “and/or” means that there may be three relations, for instance, A and/or B, which may mean that A exists alone, both A and B exist, or B exists alone. The character “/” generally means an “or” relation between two associated context objects. The singular forms such as “a”, “an”, and “the” are also intended to include the plural forms, unless otherwise clearly stated in the context.

It may be further understood that terms “first”, “second”, etc. are used to describe various information, but such information is not limited to these terms. The terms are merely used to distinguish the same type of information from each other, and do not indicate a particular order or importance. In fact, expressions “first” and “second” may be used interchangeably. For instance, without departing from the scope of the disclosure, first information may also be called second information, and similarly, second information may also be called first information.

It may be further understood that although the operations are described in a specific order in the drawings in the examples of the disclosure, it should not be understood that the operations are required to be executed in the specific order or serial order shown or all the operations shown are required to be executed to obtain desired results. Under specific circumstances, multitasking and parallel processing may be advantageous.

Those skilled in the art could easily conceive of other implementation solutions of the disclosure upon consideration of the description and the invention disclosed here. The disclosure is intended to cover any variations, uses or adaptive changes of the disclosure, which follow the general principles of the disclosure and include common general knowledge or conventional technical means not disclosed in the art. The description and the examples are regarded as merely illustrative, and the true scope and spirit of the disclosure are indicated by the following claims.

It should be understood that the disclosure is not limited to a precise structure described above and illustrated in the accompanying drawings, and can have various modifications and changes without departing from the scope. The scope of the disclosure is limited merely by the appended claims.

In order to solve problems in the related art, the disclosure provides a connection release method, a connection release apparatus, and a storage medium.

A first aspect of an example of the disclosure provides a connection release method. The connection release method is applied to relay user equipment (UE) and includes:
determining, in response to detecting that remote UE transmits first data, a data inactivity timer corresponding to the remote UE, and controlling the data inactivity timer to start timing, where the data inactivity timer is configured to control radio resource control (RRC) connection of the remote UE.

In an embodiment, the first data includes at least one of the following:
a media access control (MAC) service data unit (SDU) or a media access control (MAC) protocol data unit (PDU) carrying a radio interface (Uu interface) bearer of the remote UE;
an MAC SDU or an MAC PDU carrying a sidelink PC5 bearer of the remote UE; and
an MAC SDU or an MAC PDU carrying data related to the remote UE.

In an embodiment, a plurality of the remote UE are provided.

The method further includes:
receiving data inactivity timer duration transmitted by each of remote UE.

In an embodiment, a plurality of the remote UE are provided.

The method further includes:
receiving data inactivity timer duration transmitted by a network device, where the data inactivity timer duration corresponds to at least one of remote UE.

In an embodiment, the method further includes:
determining the data inactivity timer duration of the remote UE; and transmitting, in response to exceeding the data inactivity timer duration, a first instruction message to the remote UE corresponding to the data inactivity timer of timeout.

In an embodiment, the first instruction message is configured to instruct the remote UE to enter an idle state; and/or to instruct the remote UE to reestablish an RRC connected state.

A second aspect of an example of the disclosure provides a connection release method. The connection release method is applied to remote user equipment (UE) and further includes:
determining a data inactivity timer, where the data inactivity timer is controlled by a relay to start timing; and the relay determines to control the data inactivity timer to start timing on the basis of data transmitted by the remote UE; and
transmitting data inactivity timer duration to relay UE.

In an embodiment, the method further includes:
receiving a first instruction message transmitted by the relay UE, where the first instruction message is configured to instruct the remote UE to enter an idle state; and/or to instruct the remote UE to reestablish an RRC connected state.

A third aspect of an example of the disclosure provides a connection release method. The connection release method is applied to a network device and further includes:
determining a data inactivity timer, where the data inactivity timer is controlled by a relay to start timing; and the relay determines to control the data inactivity timer to start timing on the basis of data transmitted by the remote UE; and
transmitting data inactivity timer duration to relay UE, where the data inactivity timer duration corresponds to at least one of remote UE.

A fourth aspect of an example of the disclosure provides a connection release method. The connection release method is applied to remote user equipment (UE) and further includes:
determining a data inactivity timer; and determining, in response to detecting that second data is transmitted, to start timing by the data inactivity timer.

In an embodiment, the second data includes at least one of the following:
a sidelink media access control (MAC) service data unit (SDU) or a sidelink media access control (MAC) protocol data unit (PDU) carrying a Uu bearer of the remote UE; and
an MAC SDU or an MAC PDU carrying data transmitted to a base station.

In an embodiment, the method further includes:
receiving data inactivity timer duration transmitted by a network device; and executing a first operation in response to timeout of the data inactivity timer.

In an embodiment, the executing a first operation includes at least one of the following operations:
entering an idle state;
reestablishing an RRC connected state; and
transmitting a second instruction message to relay UE.

In an embodiment, the second instruction message is configured to indicate a connection state of the remote UE; and/or the second instruction message is configured to instruct the relay UE to release a Uu bearer corresponding to the remote UE.

A fifth aspect of an example of the disclosure provides a connection release method. The connection release method is applied to relay UE and includes:
receiving a second instruction message, where the second instruction message is transmitted by the remote UE under the condition of timeout of a data inactivity timer, and the data inactivity timer starts timing when the remote UE detects that second data is transmitted.

In an embodiment, the second instruction message is configured to indicate a connection state of the remote UE; and/or the second instruction message is configured to instruct the relay UE to release a Uu bearer corresponding to the remote UE.

In an embodiment, after receiving a second instruction message, the relay UE executes at least one of the following operations:
releasing a Uu bearer corresponding to the remote UE; and transmitting a third instruction message to a network device, where the third instruction message is configured to indicate timeout of the data inactivity timer of the remote UE.

A sixth aspect of an example of the disclosure provides a connection release method. The connection release method is applied to a network device and includes:
transmitting data inactivity timer duration to remote UE, where the data inactivity timer duration is used for configuring a timer by the remote UE, and the remote UE detects that second data is transmitted and determines to start timing by the data inactivity timer.

In an embodiment, the method further includes:
receiving a third instruction message; and determining timeout of the data inactivity timer of the remote UE on the basis of the third instruction message.

A seventh aspect of an example of the disclosure provides a connection release apparatus. The connection release apparatus is applied to relay user equipment (UE) and includes:
a determination module configured to determine, in response to detecting that remote UE transmits first data, a data inactivity timer corresponding to the remote UE, and control the data inactivity timer to start timing, where the data inactivity timer is configured to control RRC connection of the remote UE.

In an embodiment, the first data includes at least one of:
a media access control (MAC) service data unit (SDU) or a media access control (MAC) protocol data unit (PDU) carrying a radio interface (Uu interface) bearer of the remote UE;
an MAC SDU or an MAC PDU carrying a sidelink PC5 bearer of the remote UE; and an MAC SDU or an MAC PDU carrying data related to the remote UE.

In an embodiment, a plurality of the remote UE are provided.

The apparatus further includes a reception module.

The reception module is configured to receive data inactivity timer duration transmitted by each of remote UE.

In an embodiment, a plurality of the remote UE are provided.

The reception module is further configured to receive data inactivity timer duration transmitted by a network device, where the data inactivity timer duration corresponds to at least one of remote UE.

In an embodiment, the determination module is further configured to:
determine the data inactivity timer duration of the remote UE; and transmit, in response to exceeding the data inactivity timer duration, a first instruction message to the remote UE corresponding to the data inactivity timer that timed out.

In an embodiment, the first instruction message is configured to instruct the remote UE to enter an idle state; and/or to instruct the remote UE to reestablish an RRC connected state.

An eighth aspect of an example of the disclosure provides a connection release apparatus. The connection release apparatus is applied to remote user equipment (UE) and includes:
a determination module configured to determine a data inactivity timer, where the data inactivity timer is controlled by a relay to start timing; and the relay determines to control the data inactivity timer to start timing on the basis of data transmitted by the remote UE.

A transmission module is configured to transmit data inactivity timer duration to relay UE.

In an embodiment, the apparatus further includes: a reception module.

The reception module is configured to receive a first instruction message transmitted by the relay UE, where the first instruction message is configured to instruct the remote UE to enter an idle state; and/or to instruct the remote UE to reestablish an RRC connected state.

A ninth aspect of an example of the disclosure provides a connection release apparatus. The connection release apparatus is applied to a network device and includes:
a determination module configured to determine a data inactivity timer, where the data inactivity timer is controlled by a relay to start timing; and the relay determines to control the data inactivity timer to start timing on the basis of data transmitted by remote UE; and
a transmission module configured to transmit data inactivity timer duration to relay UE, where the data inactivity timer duration corresponds to at least one of the remote UE.

A tenth aspect of an example of the disclosure provides a connection release apparatus. The connection release apparatus is applied to remote user equipment (UE) and includes:
a determination module configured to determine a data inactivity timer; and determine, in response to detecting that second data is transmitted, to start timing by the data inactivity timer.

In an embodiment, the second data includes at least one of:
a sidelink media access control (MAC) service data unit (SDU) or a sidelink media access control (MAC) protocol data unit (PDU) carrying a Uu bearer of the remote UE; and
an MAC SDU or an MAC PDU carrying data transmitted to a base station.

In an embodiment, the apparatus further includes: a reception module.

The reception module is configured to receive data inactivity timer duration transmitted by a network device; and execute a first operation in response to timeout of the data inactivity timer.

In an embodiment, the first operation includes at least one of the following operations:
entering an idle state;
reestablishing an RRC connected state; and
transmitting a second instruction message to relay UE.

In an embodiment, the second instruction message is configured to indicate a connection state of the remote UE; and/or the second instruction message is configured to instruct the relay UE to release a Uu bearer corresponding to the remote UE.

An eleventh aspect of an example of the disclosure provides a connection release apparatus. The connection release apparatus is applied to relay UE and includes:
a reception module configured to receive a second instruction message, where the second instruction message is transmitted by remote UE under the condition of timeout of a data inactivity timer, and the data inactivity timer starts timing when the remote UE detects that second data is transmitted.

In an embodiment, the second instruction message is configured to indicate a connection state of the remote UE; and/or the second instruction message is configured to instruct the relay UE to release a Uu bearer corresponding to the remote UE.

In an embodiment, after the second instruction message is received, the relay UE executes at least one of the following operations:
releasing a Uu bearer corresponding to the remote UE; and transmitting a third instruction message to a network device, where the third instruction message is configured to indicate timeout of the data inactivity timer of the remote UE.

A twelfth aspect of an example of the disclosure provides a connection release apparatus. The connection release apparatus is applied to a network device and includes:
a transmission module configured to transmit data inactivity timer duration to remote UE, where the data inactivity timer duration is used for configuring the data inactive timer by the remote UE; and the remote UE detects that second data is transmitted and determines to start timing by the data inactivity timer.

In an embodiment, the apparatus further includes: a reception module.

The reception module is configured to receive a third instruction message; and determine timeout of the data inactivity timer of the remote UE on the basis of the third instruction message.

A thirteenth aspect of an example of the disclosure provides a connection release apparatus. The connection release apparatus includes:
a processor; and a memory configured to store an instruction executable by the processor. The processor is configured to execute the connection release method according to the first aspect or any one of the embodiments of the first aspect, or the connection release method according to the second aspect or any one of the embodiments of the second aspect, or the connection release method according to the third aspect or any one of the embodiments of the third aspect, or the connection release method according to the fourth aspect or any one of the embodiments of the fourth aspect, or the connection release method according to the fifth aspect or any one of the embodiments of the fifth aspect, or the connection release method according to the sixth aspect or any one of the embodiments of the sixth aspect.

A fourteenth aspect of an example of the disclosure provides a non-transitory computer-readable storage medium. When an instruction of the storage medium is executed by a processor of a mobile terminal, the mobile terminal can execute the connection release method according to the first aspect or any one of the embodiments of the first aspect, or the connection release method according to the second aspect or any one of the embodiments of the second aspect, or the connection release method according to the third aspect or any one of the embodiments of the third aspect, or the connection release method according to the fourth aspect or any one of the embodiments of the fourth aspect, or the connection release method according to the fifth aspect or any one of the embodiments of the fifth aspect, or the connection release method according to the sixth aspect or any one of the embodiments of the sixth aspect.

The technical solution according to the examples of the disclosure may have the following beneficial effects: the data inactivity timer is configured for the remote UE, and the data inactivity timer of the remote UE is controlled to start timing on the basis of the relay UE, such that RRC connection may be released on the basis of the data inactivity timer. A problem that a remote UE state understood by the remote UE is inconsistent with that understood by the network device because the remote UE does not correctly receive a release message of the network device can be avoided.

It should be understood that the above general description and the following detailed description are merely illustrative and explanatory, and cannot limit the disclosure.

1. A connection release method, performed by a communication system, wherein the communication system comprises relay user equipment (UE), and the connection release method comprising:
in response to detecting that remote UE transmits first data, the relay UE determines a data inactivity timer corresponding to the remote UE, and to control the data inactivity timer to start timing, wherein
the data inactivity timer is configured to control radio resource control (RRC) connection of the remote UE.

2. The connection release method according to claim 1, wherein the first data comprises at least one of:
a media access control (MAC) service data unit (SDU) or a media access control (MAC) protocol data unit (PDU) carrying a radio interface (Uu interface) bearer of the remote UE;
an MAC SDU or an MAC PDU carrying a sidelink PC5 bearer of the remote UE; or
an MAC SDU or an MAC PDU carrying data related to the remote UE.

3. The connection release method according to claim 1, wherein a plurality of remote UEs are provided; and
the connection release method further comprising:
the relay UE receives data inactivity timer duration transmitted by each of remote UE.

4. The connection release method according to claim 1, wherein a plurality of remote UEs are provided; and
the connection release method further comprising:
the relay UE receives data inactivity timer duration transmitted by a network device, wherein the data inactivity timer duration corresponds to at least one of remote UE.

5. The connection release method according to claim 3, further comprising:
the relay UE determines the data inactivity timer duration of the remote UE; and
in response to exceeding the data inactivity timer duration, the relay UE transmits a first instruction message to the remote UE corresponding to the data inactivity timer that timed out.

6. The connection release method according to claim 5, wherein the first instruction message is configured to instruct at least one of:
the remote UE enters an idle state;
or,
the remote UE reestablishes an RRC connected state.

7. The connection release method according to claim 1, wherein the communication system further comprises remote user equipment (UE), and the connection release method comprising:
the remote UE determines a data inactivity timer, wherein the data inactivity timer is controlled by a relay to start timing; and the relay determines to control the data inactivity timer to start timing based on data transmitted by the remote UE; and
the remote UE transmits a data inactivity timer duration to relay UE.

8. The connection release method according to claim 7, further comprising:
the remote UE receives a first instruction message transmitted by the relay UE, wherein
the first instruction message is configured to instruct at least one of:
the remote UE enters an idle state; or, the remote UE reestablishes an RRC connected state.

9. The connection release method according to claim 1, wherein the communication system further comprises a network device, and the connection release method comprising:
the network device determines a data inactivity timer, the data inactivity timer is controlled by a relay to start timing; and the relay determines to control the data inactivity timer to start timing based on data transmitted by the remote UE; and
the network device transmits a data inactivity timer duration to relay UE, wherein the data inactivity timer duration corresponds to at least one of remote UE.

10. A connection release method, performed by a communication system, wherein the communication system comprises remote user equipment (UE), and the connection release method comprising:
the remote UE determines a data inactivity timer; and
in response to detecting that second data is transmitted, the remote UE determines to start timing by the data inactivity timer.

11. The connection release method according to claim 10, wherein the second data comprises at least one of:
a sidelink media access control (MAC) service data unit (SDU) or a sidelink media access control (MAC) protocol data unit (PDU) carrying a Uu bearer of the remote UE; or
an MAC SDU or an MAC PDU carrying data transmitted to a base station.

12. The connection release method according to claim 10, further comprising:
the remote UE receives a data inactivity timer duration transmitted by a network device; and
the remote UE executes a first operation in response to timeout of the data inactivity timer.

13. The connection release method according to claim 12, wherein the executing a first operation comprises at least one of the following:
entering an idle state;
reestablishing an RRC connected state; or
transmitting a second instruction message to relay UE.

14. The connection release method according to claim 13, wherein the second instruction message is configured to indicate at least one of:
a connection state of the remote UE;
or
the relay UE to release a Uu bearer corresponding to the remote UE.

15. The connection release method according to claim 10, wherein the communication system further comprises relay UE, and the connection release method comprising:
the relay UE receives a second instruction message, wherein
the second instruction message is transmitted by remote UE under a condition of timeout of a data inactivity timer, and the data inactivity timer starts timing when the remote UE detects that second data is transmitted.

16. The connection release method according to claim 15, wherein the second instruction message is configured to indicate at least one of:
a connection state of the remote UE;
or
the relay UE to release a Uu bearer corresponding to the remote UE.

17. The connection release method according to claim 15, wherein after receiving the second instruction message, the relay UE executes at least one of the following:
releasing a Uu bearer corresponding to the remote UE; or
transmitting a third instruction message to a network device, wherein the third instruction message is configured to indicate timeout of the data inactivity timer of the remote UE.

18. The connection release method according to claim 10, the communication system further comprises a network device, and the connection release method comprising:
the network device transmits data inactivity timer duration to remote UE;
the data inactivity timer duration is used for configuring the data inactivity timer by the remote UE, and the remote UE detects that second data is transmitted and determines to start timing by the data inactivity timer.

19. The connection release method according to claim 18, further comprising:
the network device receives a third instruction message; and
the network device determines timeout of data inactivity timer of remote UE based on the third instruction message.

20-25. (canceled)

26. A connection release apparatus, comprising:
a processor; and
a memory configured to store an instruction executable by the processor, wherein
the processor is configured to execute the connection release method according to claim 1.

27. (canceled)
